(19) United States
(12) Patent Application Publication
(10) Pub. No.: US 2014/0336977 A1
(43) Pub. Date: Nov. 13, 2014

(54) MOVING BODY PLACEMENT DETERMINING METHOD, MEASURING APPARATUS, MACHINING APPARATUS, AND STORAGE MEDIUM

(71) Applicant: CANON KABUSHIKI KAISHA, Tokyo (JP)

(72) Inventor: Yutaka NIWAYAMA, Kawasaki-shi (JP)

(73) Assignee: CANON KABUSHIKI KAISHA, Tokyo (JP)

(21) Appl. No.: 14/268,089

(22) Filed: May 2, 2014

(30) Foreign Application Priority Data
May 13, 2013 (JP) 2013-101192

(51) Int. Cl. G01B 21/16

(52) U.S. Cl. CPC G01B 21/16
USPC 702/150

(57) ABSTRACT

Provided, is a method for determining a placement of a moving body that, moves to face an object, and performs processes at a plurality of target points en the object. The method includes a first step of setting a plurality of processable areas capable of the processes by the moving body to a plurality of the target points; a second step of determining candidates regarding the placement of the moving body for each of the processable areas set in the first, step; and a third step of determining the placement of the moving body and the moving path of the moving body by solving a Generalized Traveling Salesman Problem using the candidates regarding the placement of the moving body determined in the second step.

### BACKGROUND OF THE INVENTION

1. Field of the Invention

The present invention relates to a moving body placement determining method, a measuring apparatus, a machining apparatus, and a storage medium.

2. Description of the Related Art

Measuring apparatuses or machining apparatuses should preferably have a total processing time required for measurement or machining as short as possible. Here, the measuring apparatuses are apparatuses that move a measurement tool relative to an object to be measured so as to perform a measurement operation for desired points (target points) on the object to be measured using the measurement tool. Also, the machining apparatuses are apparatuses that move a machining tool relative to an object to be machined so as to perform a machining operation for desired points (target points) on the object to be machined using the machining tool. In this case, when the measurement tool or the machining tool is a moving body, a fewer number of times of movement of the moving body is advantageous for reducing a total processing time. Thus, there have been proposed techniques that determine the placements of a moving body minimally required for covering (encompassing) all points expected to be measured or all points expected to be machined. WO 2003/064107 discloses a machining planning method for simply dividing all the machining areas into rectangulars having a predetermined size in both X-axis direction and Y-axis direction along which beams are scanned at high speed. In the method, division numbers of rectangulars in both X-axis direction and Y-axis direction are compared to each other to thereby set a scanning direction having a smaller division number, divided areas, and the placement of the moving body as a measurement condition.

However, the effect of the method disclosed in WO 2003/064107 depends greatly on the machining area of an object to be machined, and thus, can only be expected for a simple surface area such as rectangular or square. The first reason for this is that the scanning direction of the moving body is limited in the method and the second reason for this is that a condition to a machining accuracy (accuracy relative to the moving body) is not taken into account in the method. Even when the method is applied to a machining area undulated in the horizontal direction, such as an S-shaped surface, the result in which the number of placements of the moving body is minimized is not necessarily obtained due to the first reason. Even when the method is applied to a machining area such as a curved surface, a machining accuracy cannot be ensured by the limitations of an angle of incidence and the depth of focus due to the second reason.

### SUMMARY OF THE INVENTION

The present invention provides, for example, a method for determining the placements and the moving path of a moving body minimally required for covering target points on an object while ensuring accuracy of processing by the moving body which performs a measurement operation or a machining operation.

According to an aspect of the present invention, a method for determining a placement of a moving body that moves to face an object and performs processes at a plurality of target points on the object is provided that includes a first step of setting a plurality of processable areas capable of the processes by the moving body to a plurality of the target points; a second step of determining candidates regarding the placement of the moving body for each of the processable areas set in the first step; and a third step of determining the placement of the moving body and the moving path of the moving body by solving a Generalized Traveling Salesman Problem using the candidates regarding the placement of the moving body determined in the second step.

Further features of the present invention will become apparent from the following description of exemplary embodiments with reference to the attached drawings.

### BRIEF DESCRIPTION OF THE DRAWINGS

FIG. 1 is a flowchart illustrating a moving body placement determining method according to a first embodiment.

FIG. 2 is a flowchart illustrating steps included in step S1.

FIG. 3 is a flowchart illustrating steps included in step S2.

FIG. 4 is a flowchart illustrating steps included in step S21.

FIG. 5 is a flowchart illustrating steps included in step S3.

FIG. 6 is a diagram illustrating a configuration of a measuring apparatus according to one embodiment.

FIG. 7 is a diagram illustrating information to be input as accuracy condition information in step S11.

FIG. 8 is a diagram illustrating normal directions at target points.

FIG. 9 is a diagram illustrating an angle between normal vectors.

FIG. 10 is a diagram illustrating a processable area candidate.

FIGS. 11A and 11B are diagrams illustrating

processable area candidates before and after solving a Set Covering Problem (SCP).

FIG. 12 is a diagram illustrating surface shape approximation in step S211.

FIG. 13 is a diagram illustrating the postures of the moving body determined in step S21.

FIG. 14 is a diagram illustrating moving body placement candidates determined in step S22.

FIG. 15 is a diagram illustrating finally-obtained placement and moving path of the moving body.

FIG. 16 is a flowchart illustrating a variant example of steps included in step S1.

### DESCRIPTION OF THE EMBODIMENTS

Hereinafter, preferred embodiments of the

present invention will be described with reference to the drawings.

### First Embodiment

Firstly, a description will be given of a moving body placement determining method according to a first embodiment of the present invention. The determining method may be employed for an industrial apparatus (hereinafter simply referred to as “apparatus”) such as a measuring apparatus or a machining apparatus. Firstly, an object (hereinafter referred to as “work”) such as an object to be measured or an object to be machined is present, and a plurality of points to be measured or a plurality of points to be machined (hereinafter referred to as “target points”) is set on the work. The apparatus moves a measurement tool or a machining tool (hereinafter referred to as “moving body”) relative to a work so as to perform measurement or machining (hereinafter collectively referred to as “processing”). Note that the determining method may be executed as a program by a general purpose information processing device (computer) or may also be executed by an information processing device provided in an apparatus to be described below. Firstly, a description will be given of the overall flow of the moving body placement determining method according to the present embodiment. Next, a description will be given of a case where the method is specifically applied to an apparatus.

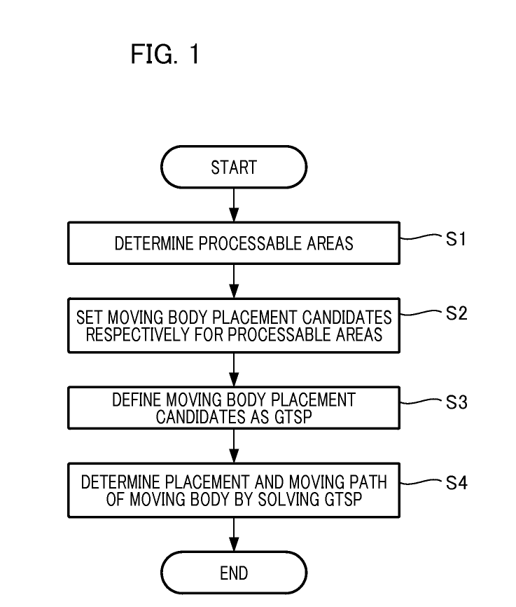

FIG. 1 is a flowchart illustrating the overall flow of processing until the placement of a moving body is determined according to the present embodiment. Processable areas are determined in step S1 (first step). Here, the term “processable area” refers to a set of target points on a work capable of being processed by a moving body with desired accuracy while maintaining the same posture. Next, moving body placement candidates are set for each of the processable areas set in step S1 in step S2 (second step). Here, the term “moving body placement candidate” refers to a candidate for the placement of a moving body such that the moving body can process a work with desired accuracy. Next, the moving body placement candidates set in step S2 are defined as a Generalized Traveling Salesman Problem (hereinafter abbreviated as “GTSP”) in step S3 (a part of third step). The GTSP defined in step S3 is solved in step S4 (a part of third step). In the present embodiment, a solution to the GTSP is obtained as a result of step S4 so that candidates for the placement of the moving body and its moving path are obtained. Hereinafter, a specific description will be given of the content of steps S1 to S4.

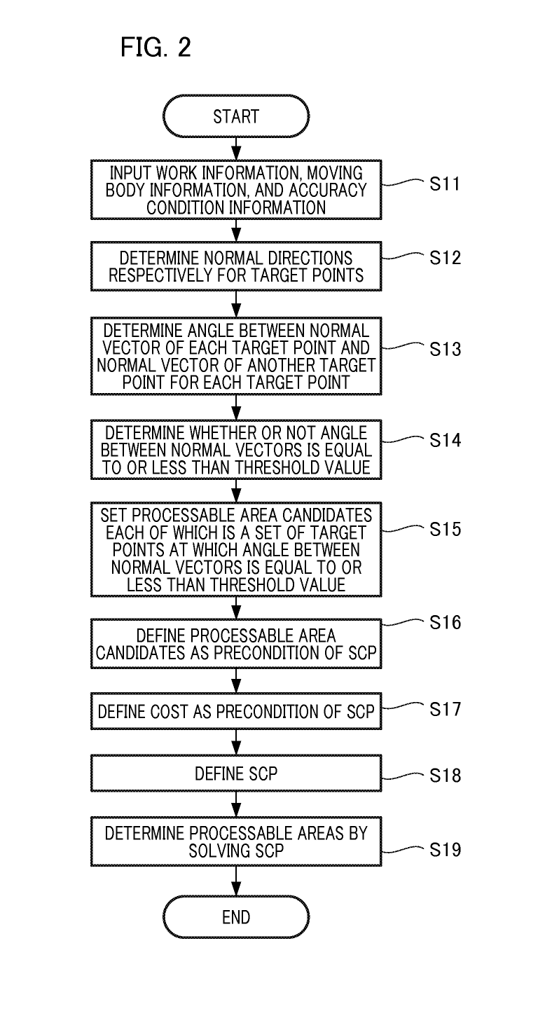

FIG. 2 is a flowchart illustrating steps included in step S1. Firstly, work information, moving body information, and accuracy condition information are input in step S11 (step 1A). Here, the term “work information” refers to information regarding the coordinates of target points, the shape of a work, and the placement of the work. The term “moving body information” refers to information regarding the shape of the moving body and information regarding the movable range of the moving body. Furthermore, the term “accuracy condition information” refers to information regarding conditions required for achieving desired accuracy upon processing by the moving body.

Next, normal directions respectively for the target points are determined with reference to work information and accuracy condition information in step S12 (step 1B) . The normal directions determined respectively for the target points may be seen as geometrical bearings at which the apparatus performs processing for the respective target points, and thus, may be one of parameters for determining accuracy of processing.

Next, an angle between the normal vector of each of the target points and the normal vector of another target point is determined for each of the target points in step S13 (step 1C). Note that, although it is preferable that the angle determined herein is determined from each combination of all normal vectors, a part of the combinations may be omitted when there is a constraint on a calculation time or the like.

Next, it is determined in step S14 (step 1D) whether or not the angle between normal vectors determined in step S13 is equal to or less than a threshold value. The threshold value used herein is determined in advance from accuracy condition information about a direction along which the moving body performs processing. The fact that the angle is equal to or less than a threshold value means that target points respectively corresponding to two normal vectors at that time satisfy desired accuracy even if the moving body performs processing while maintaining the same posture.

Next, a processable area candidate is set for each target point in step S15 (step 1E). Here, the term “processable area candidate” refers to a set of target points which are determined in step S14 to satisfy desired accuracy even if the moving body performs processing while maintaining the same posture and a candidate which may be set as a processable area in the following step.

In the subsequent steps from step S16 to step S19, the processable area candidates set respectively for the target points in step S15 are defined as a Set Covering Problem (hereinafter abbreviated as “SCP”) so as to obtain a solution. Firstly, information about the processable area candidates set respectively for the target points in step S15 is defined as a precondition in step S16 (step 1F).

Next, the cost of solving the SCP is defined as a precondition in step S17 (step 1G). In this case, the cost is the number of processable area candidates required for covering all the target points.

Next, the SCP is defined in step S18 (step 1H) so as to output a solution where the cost is minimized using the preconditions defined in steps S16 and S17. Here, database is created in accordance with the data format of a SCP solving unit. Note that an algorithm for the SCP used herein is not limited to a specific method but any algorithm may be used provided that it calculates a combination such that the number of processable areas is minimized or sub-minimized. For example, a method for calculating an exact solution, such as Mixed Integer Programming or the like, may be used or a method for calculating a near-optimal solution, such as a moderating method or the like, may also be used. The SCP will be described in detail below.

The processable areas are determined in step S19 (step 1I) by solving the SCP defined in step S18. The SCP is a problem for selecting a combination of subsets such that the number of subsets required for covering all the elements of a set U is minimized when the set U and classes of its subsets, i.e., S1, S2, . . . , and Sm are given. Note that a union of subsets S1, S2, . . . , and Sm is assumed to be equal to the set U. An algorithm used for solving the SCP is Mixed Integer Programming. Mixed Integer Programming is an algorithm for calculating an exact solution to the given problem but may take a longer calculation time depending on a problem to be solved. Here, the term “exact solution” refers to a solution in which the cost is ensured to be minimized. Thus, as a method for reducing a calculation time, Mixed Integer Programming may be combined with a branch and bound method. In order to further reduce a calculation time, a moderating method for obtaining a near-optimal solution by moderating constraints may also be used. Here, the term “near-optimal solution” refers to a solution which is regarded as useful from the viewpoints of practical use because the cost is not ensured to be minimized but is sufficiently small as compared with other solutions. In particular, in the present embodiment, the processable areas minimally required for covering all points expected to be measured or all points expected to be machined can be determined by solving the SCP using these methods.

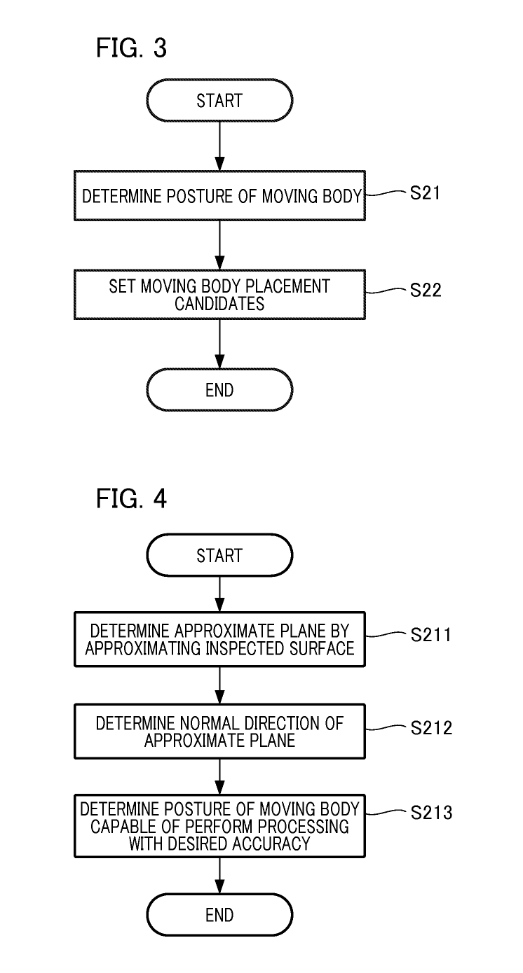

FIG. 3 is a flowchart illustrating steps included in step S2. Firstly, the posture of the moving body for each of the processable areas determined in step S1 is determined in step S21 (step 2A). Moving body placement candidates are set in step S22 (step 2B). Hereinafter, a specific description will be given of the content of steps S21 and S22.

FIG. 4 is a flowchart illustrating steps included in step S21. Firstly, an approximate plane is determined by approximating an inspected surface corresponding to a processable area in step S211 (step 2A-1). It is preferable that the moving body performs processing for each processable area while maintaining the same posture as much as possible. In order to simply determine the posture of the moving body for each processable area, it is advantageous that the processable area is represented in a simple plane shape. Here, an exemplary algorithm used, for approximation includes a least squares approximation but is not. limited to a specific method. Any algorithm provided that the processable area is represented in a simple shape may be used as described above. Although it is preferable that an approximate plane is in a plane shape in terms of approximation in the simplest manner, the approximate plane may also be in a simple curved shape such as a spherical plane or a cylindrical plane when a difference between the plane shape of the inspected surface prior to approximation and the plane shape of the inspected surface after approximation is desired to be small as much as possible.

Next, the normal direction of the approximate plane determined in step S211 is determined in step S212 (step 2A-2). The normal direction of the approximate plane may be seen as a geometrical bearing at which the apparatus performs processing for the approximate plane, and thus, may be one of parameters for determining accuracy of processing. It is preferable that the normal direction determined herein is determined for each approximate plane from the viewpoints of reduction in a calculation load imposed until the placement, of the moving body is finally determined. Note that, when the placement of the moving body in which accuracy of processing is ensured more strictly is desired to be determined, a plurality of normal directions may also be determined for one approximate plane. The same applies to the case where the approximate plane is in a simple curved shape in step S211.

The posture of the moving body which is capable of perform processing for each processable area with desired accuracy is determined in step S213 (step 2A-3) using information about the normal direction determined in step S212 and accuracy condition information about a direction along which the moving body performs processing.

Aside from the method described with reference to the flowchart in FIG. 4, an average of normal directions of all the target points in the processable area may also be determined without approximation of the inspected surface so as to determine the posture of the moving body using the obtained average normal direction in step S21. In this case, a new step of determining an average of normal directions is defined as step 2A-1, and a step of determining the posture of the moving body is defined as step 2A-2. Alternatively, a representative (one) target point may be selected from all the target points in the processable area so as to determine the posture of the moving body using the normal direction of the representative target point. In this case, a new step of selecting a representative target point is defined as step 2A-1, and a step of determining the posture of the moving body is defined as step 2A-2.

Moving body placement candidates are set for each target point in step S22 based on information about the posture of the moving body determined in step S21 and accuracy condition information about the direction and distance by which the moving body performs processing. In other words, information about the coordinates of the moving body is added to information about the posture of the moving body, so that candidates for the placement of the moving body at which posture and at which coordinates with respect to each target point are set. Although the number of moving body placement candidates set for each target point may be any, the number is preferably as many as possible from the viewpoints of the confidence of a finally obtained solution. Note that the number is variable depending on the load on computation processing performed until the moving body placement candidates are set or the load on computation processing in step S3 and subsequent steps. Examples of a method for setting moving body placement candidates include a method for setting moving body placement candidates which are equidistantly spaced apart from one another on a three-dimensional space, a method for setting moving body placement candidates which are equiangularly spaced apart from one another about the center of the target point, and the like. The method for setting moving body placement candidates may vary with the shape of a work, the specification of a moving body, or the like.

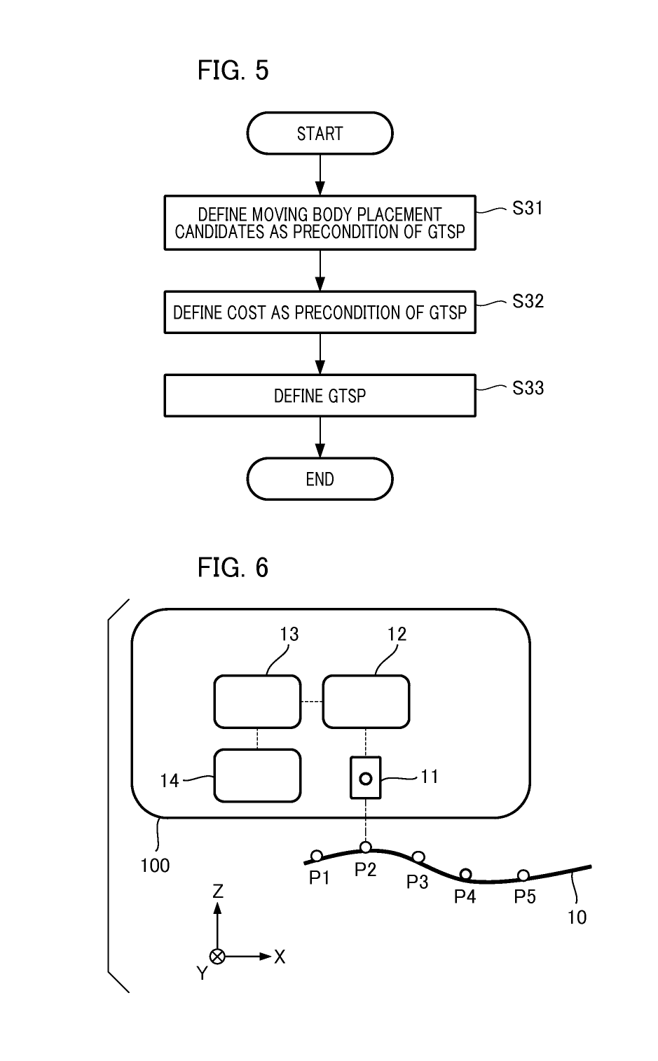

FIG. 5 is a flowchart illustrating steps included in step S3. Firstly, information about moving body placement candidates for each target point obtained in step S2 is defined as a precondition in step S31 (step 3A).

Next, the cost of solving the GTSP is defined as a precondition in step S32 (step 3B). In this case, the cost is a total travel time of a moving body required for traveling ail the target points.

The GTSP is defined in step S33 (step 3C) so as to output a solution where the cost is minimized using the preconditions defined in steps S31 and S32. Here, database is created in accordance with the data format of a GTSP solving unit. Note that an algorithm for the GTSP used herein is not limited to a specific method but any algorithm may be used provided that it calculates a combination such that the total travel time of the moving body is minimized or sub-minimized. For example, a method for calculating an exact solution may be used or a method for calculating a near-optimal solution may also be used. A detailed description will be given below of a GTSP and a Traveling Salesman Problem (hereinafter abbreviated as “TSP”) which is a similar algorithm of the GTSP.

Next, a detailed description will be given of step S4 together with the description of a GTSP and a TSP. Firstly, a description will be given of a TSP. The TSP is a problem for determining a path on which the total sum of costs required for looping all the nodes by passing through them only once is minimized in a graph in which a plurality of nodes and a cost of moving between these nodes are defined. The TSP may also be a Symmetric Traveling Salesman Problem (hereinafter abbreviated as “STSP”). The TSP may further be an Asymmetric Traveling Salesman Problem (hereinafter abbreviated as “ATSP”). The ATSP is a problem having different costs between nodes depending on the orientation of movement, whereas the STSP is a problem having the same cost between nodes regardless of the orientation of movement. An ATSP can be converted into an STSP. In practice, when an ATSP is solved, the ATSP is often converted into the STSP so as to be solved by using an STSP solving method. Examples of the STSP solving method include a method for obtaining an exact solution and a method for obtaining a near-optimal solution. In particular, examples of a method for obtaining a near-optimal solution in a short time include the Lin-Kernighan method, a simulated annealing method, a heuristic solving method such as genetic algorithms, and the like.

Next, a description will be given of a GTSP. The GTSP is a problem for determining a path on which the total sum of costs required for looping all the clusters by passing through them only once is minimized in a graph in which a plurality of clusters having sets of a plurality of nodes and a cost of moving between nodes belonging to different clusters are defined. In particular, the path determined by the TSP passes through all the nodes, whereas the path determined by the GTSP passes through only one of nodes in each cluster. In other words, the GTSP is a problem for determining the sequence of visiting clusters so as to minimize the cost of looping and selecting one node from a plurality of nodes in each cluster in a simultaneous manner. A GTSP can be converted into an ATSP. Thus, when a GTSP is solved, the GTSP can be converted into the ATSP so as to be solved by using an ATSP solving method. As described above, when an ATSP is solved, the ATSP can further be converted into the STSP so as to be solved by using an STSP solving method. Here, an exact solution to the converted STSP is ensured to be a feasible solution and an exact, solution to the original GTSP. On the other hand, a near-optimal solution to the converted STSP is not ensured to be a feasible solution to the original GTSP. In other words, the GTSP is a problem for visiting all clusters only once, but a near-optimal solution to the converted STSP may also include a situation where one cluster is visited for multiple times. By expanding the Lin-Kernighan method to the GTSP, a near-optimal solving method for the GTSP may also be directly used without converting the GTSP to the STSP. In particular, in the present embodiment, the moving body placement selected as the placement where the cost is minimized from among the moving body placement candidates and the moving path of the moving body can be determined simultaneously by solving the GTSP using these methods.

Next, a description will be given of the case where the aforementioned moving body placement determining method is specifically applied to an apparatus. Here, as an example, the moving body placement determining method according to the present embodiment is applied to a measuring apparatus that contactlessly measures the distance between a moving body and a work or the shape of the work by projecting light from the moving body to the work. FIG. 6 is a schematic: diagram illustrating a configuration of a measuring apparatus 100 according to the present embodiment. In the following drawings, mutually orthogonal X- and Y-axes are aligned in a plane with a work 10 placed thereon and the Z-axis is aligned in a direction (in the present embodiment, vertical direction) perpendicular to the XY plane. Firstly, the surface to be measured of the work 10 to be measured by the measuring apparatus 100 is a smooth curved surface, and a preset plurality of target points P (P1 to P5) is present on the surface to be measured. The measuring apparatus 100 includes a moving body 11 that stands facing the work 10, a drive unit 12 that changes the placement of the moving body 11 by moving it, a control unit 13 that transmits a drive command to the drive unit 12, and a placement determining unit 14 that determines the placement of the moving body 11 during processing (in this case, during measuring). The moving body 11 is a measurement element (measuring probe) that is movable relative to the work 10 by the operation of the drive unit 12 and projects/receives light onto/from the target points P. Note that it is preferable that light from the moving body 11 is scanned by a scanning unit (not shown, e.g., galvanometer mirror) provided within the moving body 11 at a high speed from the viewpoints of reduction in a processing time. The present invention is not necessarily limited thereto, but light may also be scanned by the movement of the moving body 11 by the operation of the drive unit 12 instead of provision of the scanning unit. When the measuring apparatus 100 has such a configuration, the placement determining unit 14 may execute the moving body placement determining method according to the present embodiment, for example, as a program. Here, while the moving body placement determining method according to the present embodiment is intended to be applied to a measuring apparatus including a non-contact, probe as a moving body, the method may also be applied to a measuring apparatus including a contact probe or may further be applied to a machining apparatus including a contact or a non-contact machining tool.

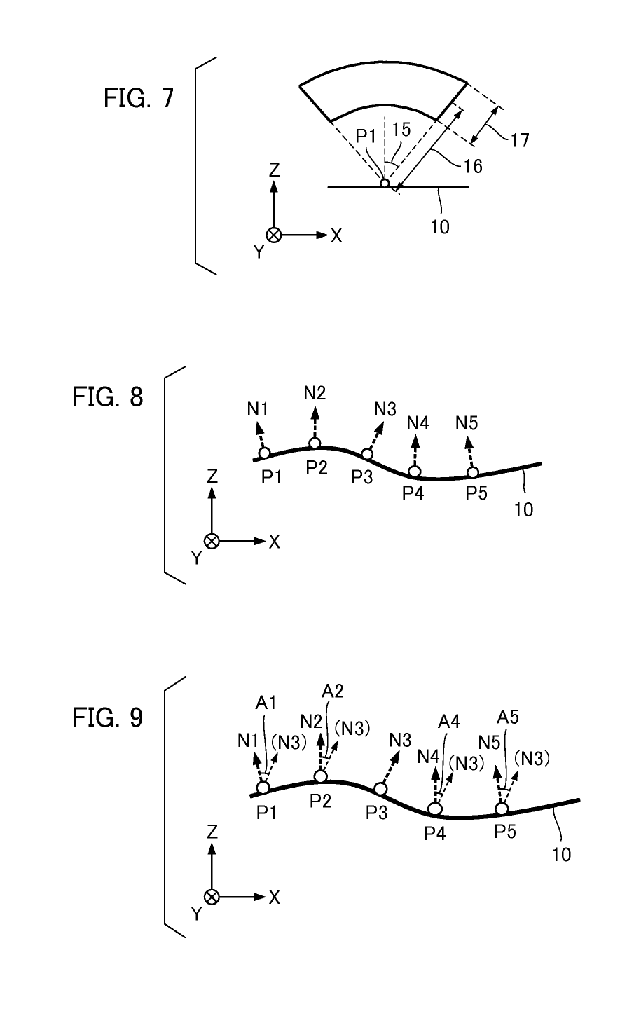

Next, a detailed description will be given of the flow for determining the placement Q of the moving body 11 provided in the measuring apparatus 100 in accordance with steps from step S1 to step S4. Firstly, when processing is started in step S1, the coordinates of the target points P, the shape of the work 10, and the placement of the work 10 as shown in FIG. 6 are input as work information by input from the operator in step S11. Likewise, the range of movement of the moving body 11 in each drive axis is input as moving body information. Furthermore, in this case, information about an angle of incidence to any target point on the moving body 11, a focal distance thereof, and the depth of focus thereof is input as accuracy condition information. FIG. 7 is a schematic diagram illustrating information to be input as accuracy condition information. As an example, an angle of incidence 15 to the target point P1 on the moving body 11, a focal distance 16 thereof, and the depth of focus 17 thereof are shown in FIG. 7.

Next, the normal directions N (N1 to N5) are respectively determined for the target, points P in step S12. FIG. 8 is a schematic diagram illustrating the normal directions N and shows the normal directions N1 to N5 respectively for the target points P1 to P5.

Next, an angle between the normal vector of each of the target points P and the normal vector of another target point P is determined in step S13. FIG. 9 is a schematic, diagram illustrating angles A1, A2, A4, and A5 between the normal vectors N1, N2, N4, and N5 of the target points P1, P2, P4, and P5, respectively, and the normal vector N3 of the target point. P3 as an example. Although not shown in FIG. 9, angles between the normal vectors N1, N2, N4, and N5 of the target points P1, P2, P4, and P5, respectively, and the normal vector corresponding thereto are also determined.

Next, it is determined in step S14 whether or not each of the angles A1, A2, A4, and A5 between the normal vectors N1, N2, N4, and N5 determined in step S13 is equal to or less than a threshold value. The threshold value used herein may be the maximum angle of incidence of the moving body 11 input, in step S11 or may also be a value having a margin based on the maximum angle of incidence.

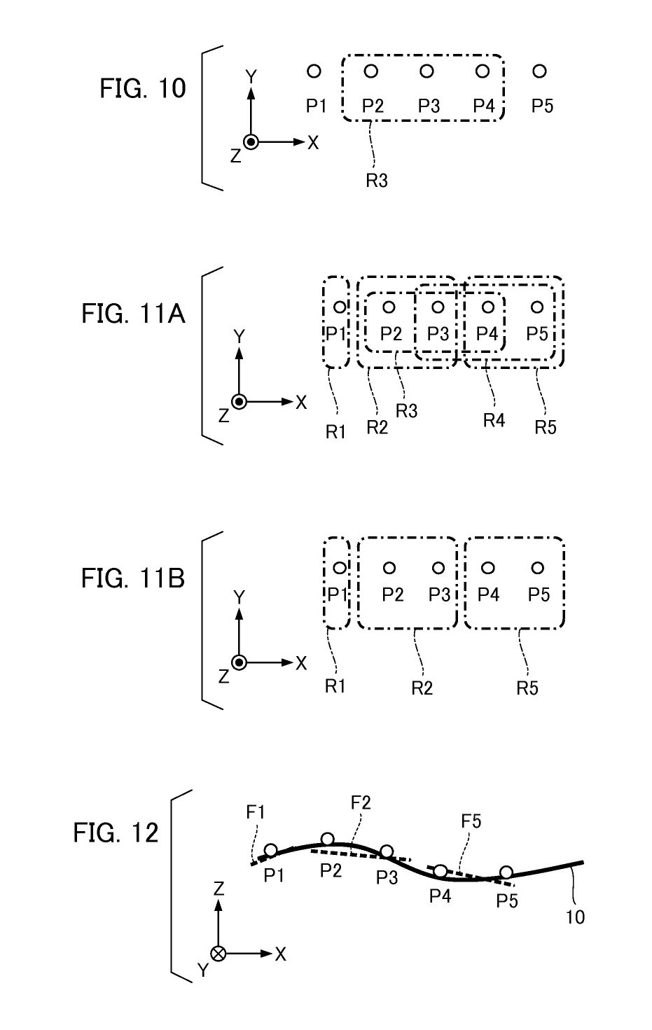

Next, the processable area candidate R is set for each target point P in step S15 using the result obtained in step S14. FIG. 10 is a plan view illustrating the processable area candidate R which may be set when each of the angles A1, A2, A4, and A5 with respect to the target point P3 is equal to or less than a threshold value as seen from the Z-axis direction of the work 10. For example, when it is determined in step S14 that each of the angles A2 and A4 is equal to or less than a threshold value, the processable area candidate R3 is set for the target point P3 as shown in FIG. 10. Although not shown in FIG. 10, the processable area candidates R (R1, R2, R4, and R5) are set respectively for other target points P1, P2, P4, and P5 based on the result obtained in step S14.

Next, an SCP is defined in steps S16 to S18 based on the processable area candidate R for each target point P and the cost of the number of the processable area candidates R required for covering all the target points P, and the SCP is solved in step S19.

FIGS. 11A and 11B are plan views illustrating examples of the processable area candidates R1 to R5 (FIG. 11A) prior to solving the SCP in step S19 and the processable areas R1, R2, and R5 (FIG. 11B) determined by solving the SCP as seen from the Z-axis direction of the work 10. The SCP is solved by using the processable area candidates R1 to R5 respectively for the target points P1 to P5 shown in FIG. 11A. Consequently, the processable areas R1, R2, and R5, which are minimally required for covering the target points P1 to P5, are determined as shown in FIG. 11B.

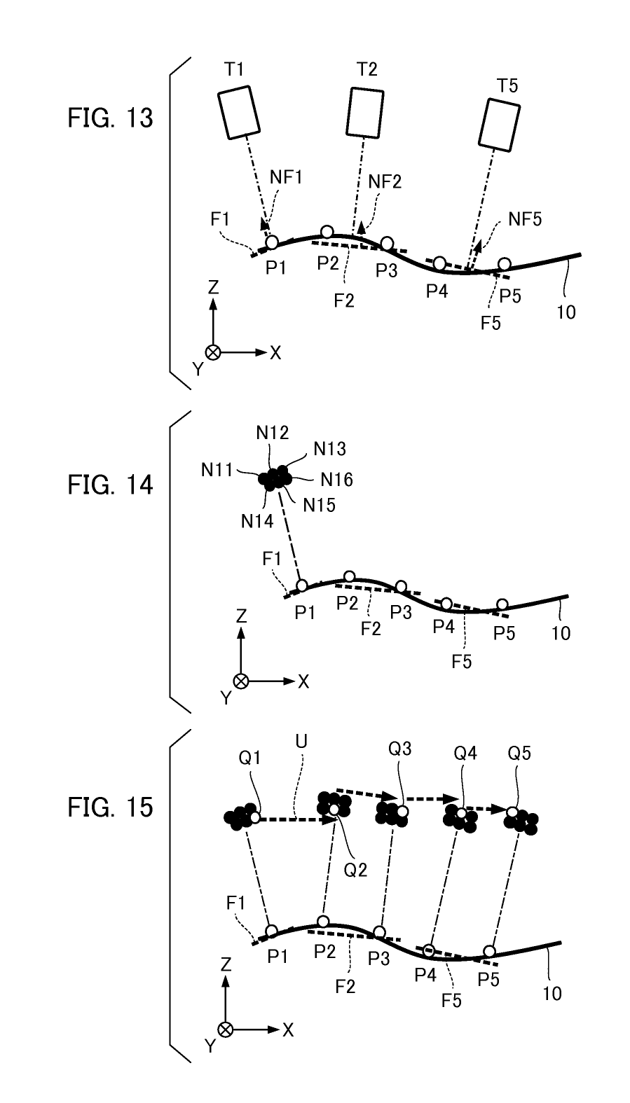

Next, the process shifts to step S2. Firstly, in step S211 of step S21, surface shape approximation is performed for the processable areas R1, R2, and R5 determined in step S1. FIG. 12 is a schematic diagram illustrating an example when planar approximation is performed for the processable areas R1, R2, and R5 shown in FIG. 11B as surface shape approximation in step S211. When planar approximation is performed for the processable areas R1, R2, and R5, approximate planes F1, F2, and F5 are determined. FIG. 13 is a schematic diagram illustrating an exemplary result obtained in steps S212 and S213 (to be described below) in step S21. Next, the normal directions NF1, NF2, and NF5 respectively for the approximate planes F1, F2, and F5 are determined in step S212, The posture of the moving body 11 is determined for each of the processable areas R1, R2, and R5 in step S213. Here, the postures of the moving body 11 to be determined, at which light can be projected onto the target points P along the normal directions NF1, NF2, and NF5, are T1, T2, and T5, respectively.

Moving body placement candidates N are set for each target points P in step S22. FIG. 14 is a schematic diagram illustrating an exemplary method for setting moving body placement, candidates N. Here, as an example, the moving body placement candidates N are set to six (N11 to N16) for the target point P1. In this case, the posture of the moving body 11 for each of the moving body placement candidates N11 to N16 is identical to the posture T1 shown in FIG. 13. Here, a range in which the coordinates of the moving body placement candidates N11 to N16 are set may be, for example, the length measurement range of the moving body 11 or the like which is one of accuracy condition information. Likewise, the moving body placement candidates N are set respectively for other target points P2 to P5.

Next, the process shifts to step S3 and the moving body placement candidates N set in step S2 are defined as a GTSP as described above. The GTSP defined in step S3 is solved in step S4. By performing a series of steps from step S1 to step S4, the moving body placements Q selected as the placements where the cost is minimized from among the moving body placement candidates K and the moving path U of the moving body 11 can be finally determined.

FIG. 15 is a diagram illustrating examples of the moving body placements Q and the moving path U of the moving body 11 which are finally obtained by the moving body placement determining method according to the present embodiment. As described above, in the present embodiment, the moving body placements Q1 to Q5 are determined from the moving body placement candidates N set respectively for the target points P1 to P5 and the moving path U of the moving body 11 is also determined by using the GTSP. In this example, the moving body placements Q1 to Q5 minimally required for covering the target points P1 to P5 are firstly selected while ensuring accuracy of processing by the moving body 11. Furthermore, when the moving body 11 moves from the placement Q2 to Q3 and moves from the placement Q4 to Q5, the moving body 11 only moves so that there is no need to change the posture of the moving body 11 itself. In other words, there is no need to change the posture of the moving body 11 in a movement between certain placements, so that a posture change operation can be reduced as much as possible during a total processing time.

As described above, according to the present embodiment, a method for determining the placements of a moving body and the moving path of the moving body minimally required for covering all the target points on an object while ensuring accuracy of processing by the moving body may be provided. Consequently, an apparatus that employs the moving body placement determining method can reduce a total processing time while ensuring accuracy of processing,

### Second Embodiment

Next, a description will be given of a moving body placement determining method according to a second embodiment of the present invention. In the first embodiment, when processable area candidates are set in step S1, an angle between the normal vector of each of the target points and the normal vector of another target point is determined for each target point so as to determine whether or not the angle between normal vectors is equal to or less than a threshold value. In contrast, in the present embodiment, when processable area candidates are set, it is determined whether or not a relative distance between target points instead of an angle between normal vectors of the target points is equal to or less than a threshold value. In the present embodiment, the steps other than step S1 are the same as those in the first embodiment.

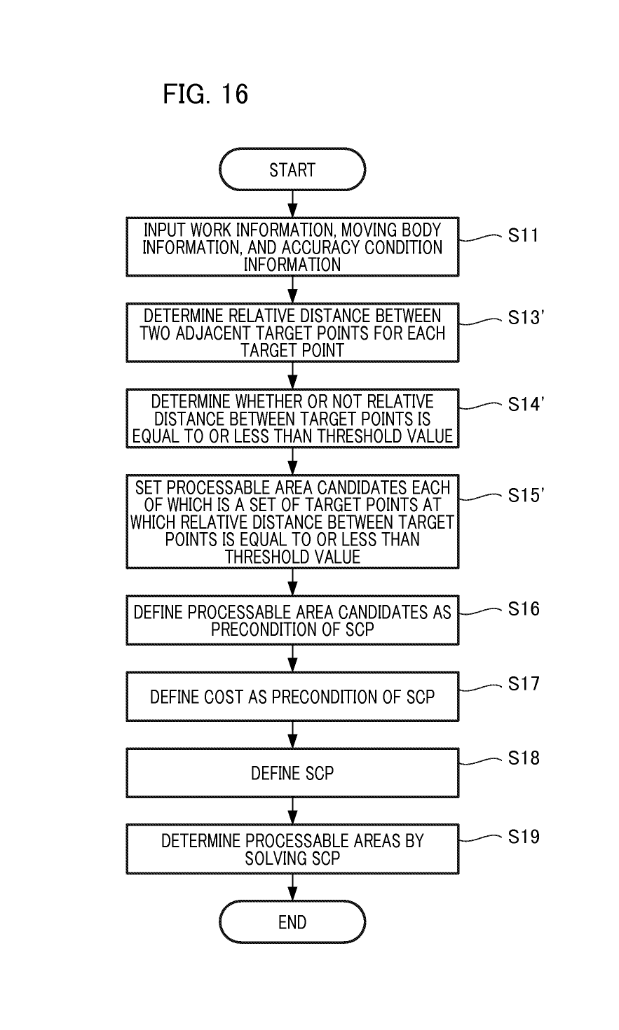

FIG. 16 is a flowchart illustrating steps included in step S1 in the present embodiment corresponding to those in the first embodiment shown in FIG. 2. In FIG. 16, a difference from the first embodiment shown in FIG. 2 is that step S12 is not required and steps S13 to S15 are changed to steps S13′ to S15′. Other steps are the same as those shown in FIG. 2, and thus, explanation thereof will be omitted.

Firstly, a relative distance between two adjacent target points is determined for each target point in step S13′ (step 1C′) after completion of step S11. The relative distance determined herein may be a distance between a tangent to a target point and a straight line which is a translation of the tangent to an adjacent target, point. Note that an adjacent, target point, may be determined in the order of the most adjacent point, the second most adjacent point, the third most adjacent point, and so on for all the target points, or may also be determined until the relative distance exceeds a threshold value.

Next, it is determined in step S14′ (step 1D′) whether or not the relative position determined in step S13′ is equal to or less than a threshold value. The threshold value used herein is determined in advance from the focal distance and the depth of focus of the moving body which are accuracy condition information. The fact that the relative position is equal to or less than a threshold value means that two adjacent target points at that time satisfy desired accuracy even if the moving body performs processing while maintaining the same posture.

Next, a processable area candidate is set for each target point in step S15′ (step 1E) . Here, the term “processable area candidate” refers to a set of target points which are determined in step S14′ to satisfy desired accuracy even if the moving body performs processing while maintaining the same posture and a candidate which may be set as a processable area in the following step.

According to the present embodiment, the same effects as those of the first embodiment can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-101192 filed on May 13, 2013, which is hereby incorporated by reference herein in its entirety.

1. A method for determining a placement of a moving body that moves to face an object and performs processes at a plurality of target points on the object, the method comprising:
a first step of setting a plurality of processable areas capable of the processes by the moving body to a plurality of the target points;
a second step of determining candidates regarding the placement of the moving body for each of the processable areas set in the first step; and
a third step of determining the placement of the moving body and the moving path of the moving body by solving a Generalized Traveling Salesman Problem using the candidates regarding the placement of the moving body determined in the second step.

2. The method according to claim 1, wherein the first step further comprises:
a step 1A of inputting information regarding the object, information regarding the moving body, and information regarding an accuracy condition of the processes;
a step 1B of determining a normal direction for each of the target points with reference to the information input in the step 1A;
a step 1C of determining an angle between the normal vector of each of the target points and the normal vector of another target point for each of the target points with reference to the normal directions determined in the step 1B;
a step 1D of determining whether or not the angle determined in the step 1C is equal to or less than a threshold value:
a step 1E of setting the candidates of the processable areas as a set of the target points for which it has been determined in the step 1D that the angle is equal to or less than a threshold value;
a step 1F of defining the candidates of the processable areas set in the step 1E as a precondition of a Set Covering Problem;
a step 1G of defining a cost as a precondition of the Set Covering Problem;
a step 1H of defining the Set Covering Problem so as to determine a solution where the cost defined in the step 1G is minimized; and
a step 1I of setting the processable areas by solving the Set Covering Problem defined in the step 1H.

3. The method according to claim 2, wherein, in the steps 1C and 1D excluding the step 1B, a relative distance between two adjacent target points is used for each of the target points instead of the angle.

4. The method according to claim 2, wherein the information regarding the object includes information about coordinates of the target points, a shape of the object, and a placement of the object.

5. The method according to claim 2, wherein the information regarding the moving body includes information about a shape of the moving body and a movable range of the moving body.

6. The method according to claim 2, wherein the cost is the number of the candidates of the processable areas required for covering all the target points.

7. The method according to claim 1, wherein the second step comprises:
a step 2A of determining a posture of the moving body for each of the processable areas; and
a step 2B of setting candidates regarding the placement of the moving body.

8. The method according to claim 7, wherein the step 2A comprises:
a step 2A-1 of determining an approximate plane by approximating an inspected surface corresponding to the processable area;
a step 2A-2 of determining a normal direction of the approximate plane determined in the step 2A-1; and
a step 2A-3 of determining the posture of the moving body based on the normal direction determined in the step 2A-2.

9. The method according to claim 7, wherein the step 2A comprises:
a step 2A-1 of determining an average of the normal directions of the target points in the processable area; and
a step 2A-2 of determining the posture of the moving body based on the average determined in the step 2A-1.

10. The method according to claim 7, wherein the step 2A comprises:
a step 2A-1 of selecting one of the normal directions of the target points in the processable area; and
a step 2A-2 of determining the posture of the moving body based on the one normal direction selected in the step 2A-1.

11. The method according to claim 1, wherein the third step comprises:
a step 3A of defining candidates regarding the placement of the moving body as a precondition of the Generalized Traveling Salesman Problem;
a step 3B of defining a cost as a precondition of the Generalized Traveling Salesman Problem; and
a step 3C of defining the Generalized Traveling Salesman Problem so as to determine a solution where the cost defined in the step 3B is minimized.

12. The method according to claim 11, wherein the cost is travel time of the moving body required for the processes to ail the target points by the moving body.

13. The method according to claim 1, wherein the processes includes measuring or machining.

14. A measuring apparatus that measures an object, wherein a placement of a moving body that moves to face an object and measures a plurality of target points set on the object is determined by a method for determining a placement of a moving body that moves to face an object and performs processes at a plurality of target points on the object, the method comprising:
a first step of setting a plurality of processable areas capable of the processes by the moving body to a plurality of the target points;
a second step of determining candidates regarding the placement of the moving body for each of the processable areas set in the first step; and
a third step of determining the placement of the moving body and the moving path of the moving body by solving a Generalized Traveling Salesman Problem using the candidates regarding the placement of the moving body determined in the second step.

15. A machining apparatus that machines an object, wherein a placement of a moving body that moves to face an object and machines a plurality of target points set on the object is determined by a method for determining a placement of a moving body that moves to face an object and performs processes at a plurality of target points on the object, the method comprising:
a first step of setting a plurality of processable areas capable of the processes by the moving body to a plurality of the target points;
a second step of determining candidates regarding the placement of the moving body for each of the processable areas set in the first step; and
a third step of determining the placement of the moving body and the moving path of the moving body by solving a Generalized Traveling Salesman Problem using the candidates regarding the placement of the moving body determined in the second step.

16. A non-transitory storage medium on which is stored a program for making an information processor execute a method for determining a placement of a moving body that moves to face an object and performs processes at a plurality of target points on the object, the method comprising:
a first step of setting a plurality of processable areas capable of the processes by the moving body to a plurality of the target points;
a second step of determining candidates regarding the placement of the moving body for each of the processable areas set in the first step; and
a third step of determining the placement of the moving body and the moving path of the moving body by solving a Generalized Traveling Salesman Problem using the candidates regarding the placement of the moving body determined in the second step.
